(19) United States
(12) Patent Application Publication
(10) Pub. No.: US 2018/0183586 A1
(43) Pub. Date: Jun. 28, 2018

(54) ASSIGNING USER IDENTITY AWARENESS TO A CRYPTOGRAPHIC KEY

(71) Applicant: Intel Corporation, Santa Clara, CA (US)

(72) Inventors: Abhilasha Bhargav-Spantzel, Santa Clara, CA (US); Ned M. Smith, Beaverton, OR (US); Hormuzd M. Khosravi, Portland, OR (US); Sze Yiu Chau, Hillsboro, OR (US)

(21) Appl. No.: 15/392,205

(22) Filed: Dec. 28, 2016

(51) Int. Cl. H04L 9/08; G06F 21/32; H04L 9/32

(52) U.S. Cl. CPC H04L 9/0861; G06F 21/32; H04L 2463/082; H04L 9/3263; G06F 2221/2111; H04L 9/3247

(57) ABSTRACT

Various systems and methods for performing cryptographic operations based on an authentication policy are discussed. In an example, an authentication policy for implementing a user authentication factor (or multiple factors) may be deployed at a client computing device to control generation and use of a cryptographic key. Operations for generating a cryptographic key in accordance with an authentication policy may include: receiving the authentication policy from a policy broker, generating the cryptographic key in response to receipt of the user authentication factor defined by the authentication policy, generating attestation data that indicates compliance with the authentication policy, and communicating the attestation data to the policy broker. Operations for using the cryptographic key in accordance with the authentication policy may include: receiving a request to access the cryptographic key, and accessing the cryptographic key in response to successful receipt of the user authentication factor defined by the authentication policy.

### TECHNICAL FIELD

Embodiments described herein generally relate to the generation and use of cryptographic keys with a computing system and in particular, to the generation and use of cryptographic keys in compliance with authentication factor policies for the authentication of a human user.

### BACKGROUND

From email to medical records to electronic commerce, the use of security has become a necessity for the exchange of digitized information. In countless settings, a user (e.g., a user through a user's software application or device) may obtain access to another electronic computer system or network by authentication of a cryptographic key. Such cryptographic keys may be used in implementations of a public key infrastructure (PM) that utilize digital certifications and public key encryption techniques for authentication and encryption of data and communications.

Existing authentication approaches implement limited measures to protect generated keys, such as by placing the secret keys in secure storage and employing basic user-level authentication to access such keys. However, existing authentication solutions lack the sophistication of being able to leverage the availability of a variety of authentication factors in a flexible and configurable manner for respective software applications.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIGS. 1A, 1B, and 1C illustrate an overview the definition and use of an authentication policy associated with a user authentication factor, according to an example;

FIG. 2 illustrates a flowchart of techniques performed for establishing and deploying an authentication policy, based on an association of the authentication policy with generated authentication credentials, according to an example.

FIGS. 3A and 3B illustrate sequential operations performed among computing system components for the generation and attestation of authentication credentials, in compliance with authentication factors defined in an authentication policy, according to an example;

FIG. 4 illustrates a flowchart of techniques performed for accessing and verifying authentication credentials, based on an association of the authentication policy with the use of authentication credentials, according to an example;

FIG. 5 illustrates sequential operations performed among computing system components for the use and attestation of authentication credentials, in compliance with authentication factors defined in an authentication policy, according to an example;

FIG. 6 is a flowchart illustrating a method of performing cryptographic operations including generation of a cryptographic key according an authentication factor policy, according to an example;

FIG. 7 is a flowchart illustrating a method of performing cryptographic operations including accessing a cryptographic key according an authentication factor policy, according to an example;

FIG. 8 illustrates a block diagram of components in an authentication system configured for implementing the techniques described herein, according to an example; and

FIG. 9 illustrates a block diagram for an example electronic processing system upon which any one or more of the techniques (e.g., operations, processes, methods, and methodologies) described herein may be performed, according to an example.

### DETAILED DESCRIPTION

In the following description, methods, configurations, and related apparatuses are disclosed for authenticating a human user for uses such as access to multiple distributed systems or operation of applications that require varying levels of security. In particular, the techniques discussed herein are relevant to enforcing user authentication and managing the user authentication used to generate keys and certificates, so that different distributed applications may enforce specific types of authentication requirements (including multi-factor authentication (MFA)) to generate or access a particular authentication credential. As discussed in the following examples, the use of this approach may enable cryptographic keys to become identity aware and context aware to ensure sufficient security for the generation and use of a cryptographic key, and to prevent misuse of a credential, certificate, or other token.

The techniques discussed herein may be used in adaptations of existing (legacy) cryptographic key designs to enforce MFA, yet without affecting the existing cryptographic algorithms or workflows. Thus, the use of the presently described techniques do not involve redesigning an entire deployment infrastructure or existing applications. The use of the presently described techniques may also provide confidence that a user authentication process occurred correctly according to a desired configuration, through an attestation mechanism. Further, the deployment of the described authentication policies enables risk management by providing a policy that may deploy combinations of authentication factors that are strong enough to match the intended purposes of an application, while at the same time, customizing the authentication requirements to users' individual needs and capabilities (e.g., users who are unable to use a fingerprint; users who cannot operate a smartphone for multi-factor verification, etc.).

Existing digital certificates are unable to inform a verifier whether or not the private key used to authenticate a challenge-response was (or is) being controlled by the intended human or was taken and used by another. Additionally, existing cryptographic service providers (CSPs) often support forms of user authentication techniques ranging among passwords/PINs, biometrics, multi-factor authentication, and even context-based authentication and auto-lock. However, the verifier accepting a certificate from a CSP typically has no knowledge of which authentication method or factor was (or is) being applied. The techniques herein address this limitation through the association and enforcement of specific user authentication factors, at the time that the authentication products (e.g., keys or digital certificates) are created and used.

CSPs also support general auditing of security relevant events, such as when keys are generated, used, and destroyed, as well as when users authenticate to the CSP and how. However, CSP audit information is generally not available to a certificate authority (CA) at the time that digital certificates are issued, nor is such audit information available to a verifier when a challenge-response exchange happens at a later time. The techniques discussed herein address these constraints by incorporating a user authentication context so that a signature verifier is able to define (and include) a specific authentication type from a human user as part of the use of cryptographic credentials in the certificate verification process.

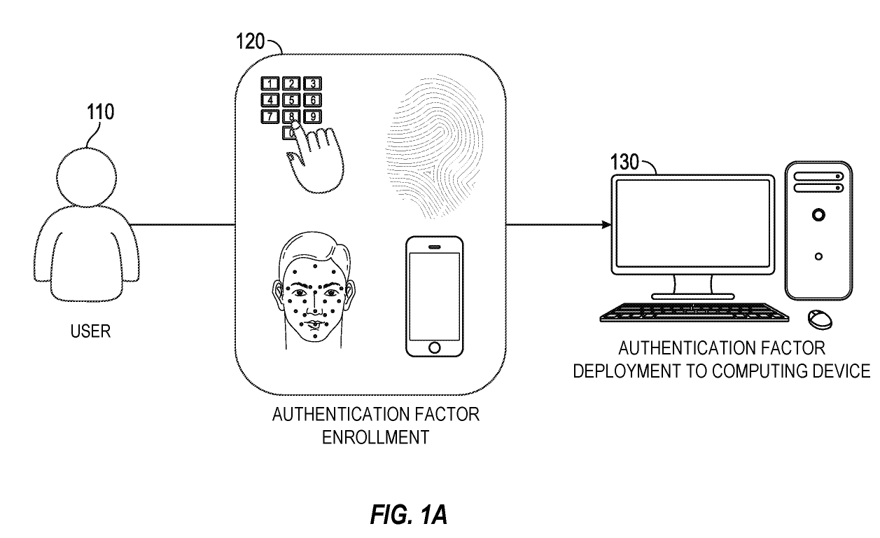

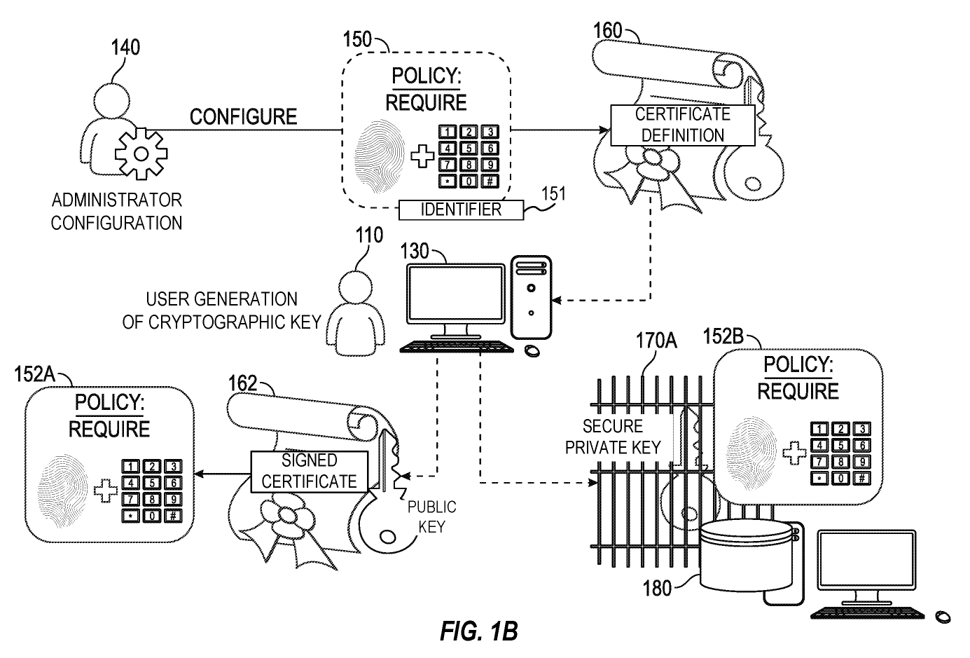

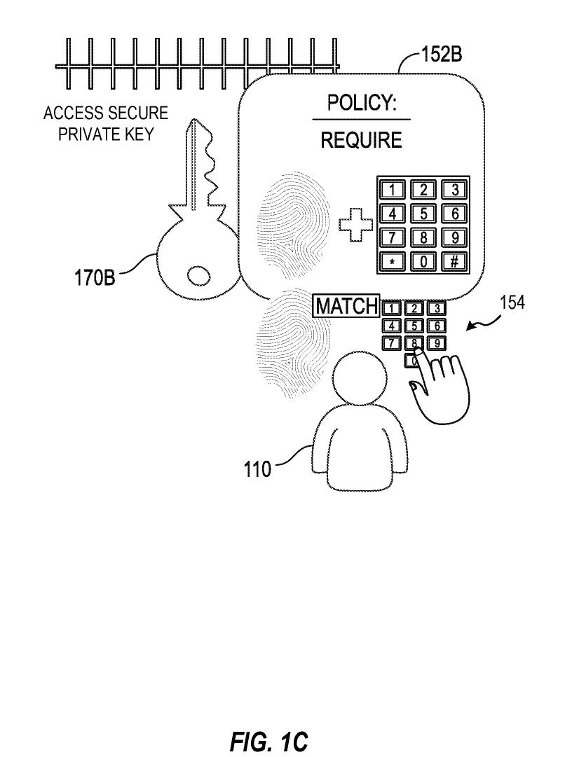

FIGS. 1A, 1B, and 1C illustrate an overview the definition and use of an authentication policy associated with authentication credentials. As shown in FIG. 1A, a human user 110 enrolls (e.g., defines, establishes, creates) a collection of one or more authentication factors 120 on a computing device 130. Examples of user authentication factors may include, but are not limited to, alphanumeric characters and symbols such as a password or a personal identification number (PIN), a biometric scan, a fingerprint capture, facial recognition, voice recognition, or other characteristics that are unique to a human user (e.g., something in the user's knowledge, possession, or an inherent property of the user). The collection of authentication factors 120 define the respective factors (and the respective combination of factors) that are available for the human user 110 to authenticate their identity, at a subsequent time, to access some feature or capability. The human user 110 may enroll any number of authentication factors 120; however opting out of (e.g., removing) one of the authentication factors 120 may reduce the available factors available to the human user 110.

As shown in FIG. 1B, an administrator 140 configures a definition of one or more policy templates 150, that are used to define respective authentication policies to require the use of certain user authentication factors. For example, the administrator 140 may be associated with a policy broker, a certificate authority, a trusted party, or other entity. The administrator 140 configures the policy templates 150 to reference the types of authentication factors 120 enrolled by the human user 110. The policy templates 150 are used to establish a certificate definition 160, meaning that a digital certificate may be created in response to satisfaction of the particular user authentication policy indicated by the policy template 150.

In an example, the specific type and combination of user authentication factors that are to be enforced by a policy are associated with an identifier 151, which is an instance of an identifier that is referred to herein as an Authentication Factor Suite Identifier (AFSI). An AFSI may be used to represent an authentication factor or any combination of authentication factors. A configuration established by the administrator 140 may utilize an AFSI to indicate the particular combination of authorization factors to be enforced by a policy. For example, the identifier 151 (e.g., an AFSI) may indicate that a combination of a fingerprint and a numeric PIN verification is required for user authentication to generate a certificate with the certificate definition 160. The techniques for associating a particular AFSI of a policy with a cryptographic key and a set of credentials for the user 110 (and a user's device) are further discussed below.

As shown in FIG. 1B, the human user 110, using their computing device 130, initiates generation of a cryptographic key (e.g., as part of generating a private/public key pair) in compliance with requirements imposed by the certificate definition 160 and the policy template 150. In more detail, the computing device 130 generates the private and the public key according to the use of the authentication factors indicated by the identifier 151. This private and public key set are then established as follows: the computing device 130 generates the private key (and the accompanying public key) according to the requirements of the policy template 150 (in compliance with the authentication factors that are identified with the identifier 151); and the computing device 130 generates a signed digital certificate 162 according to the characteristics of the certificate definition 160.

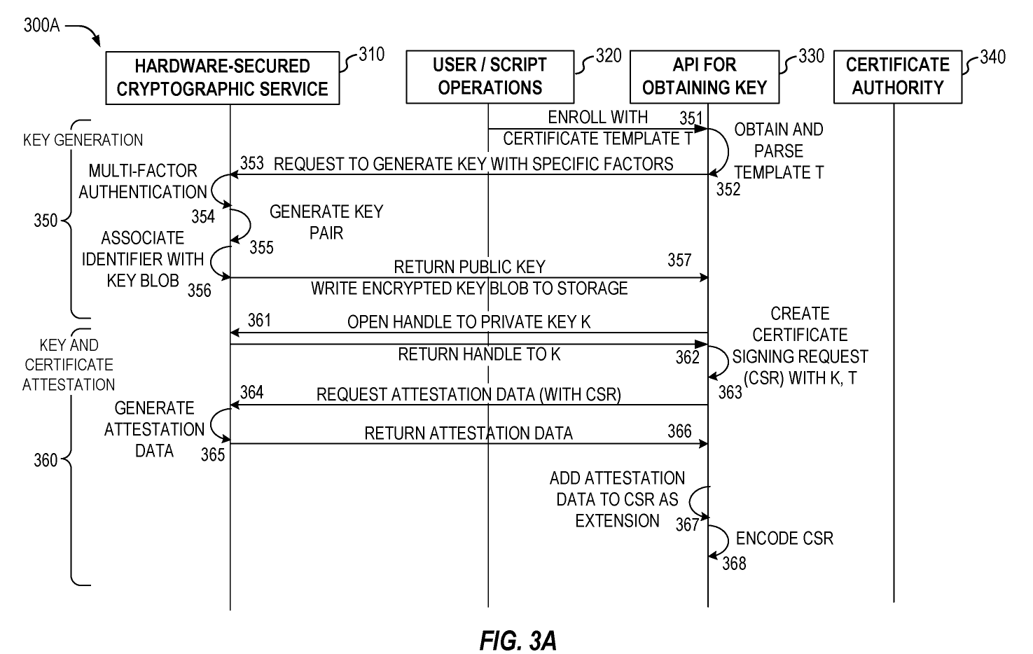

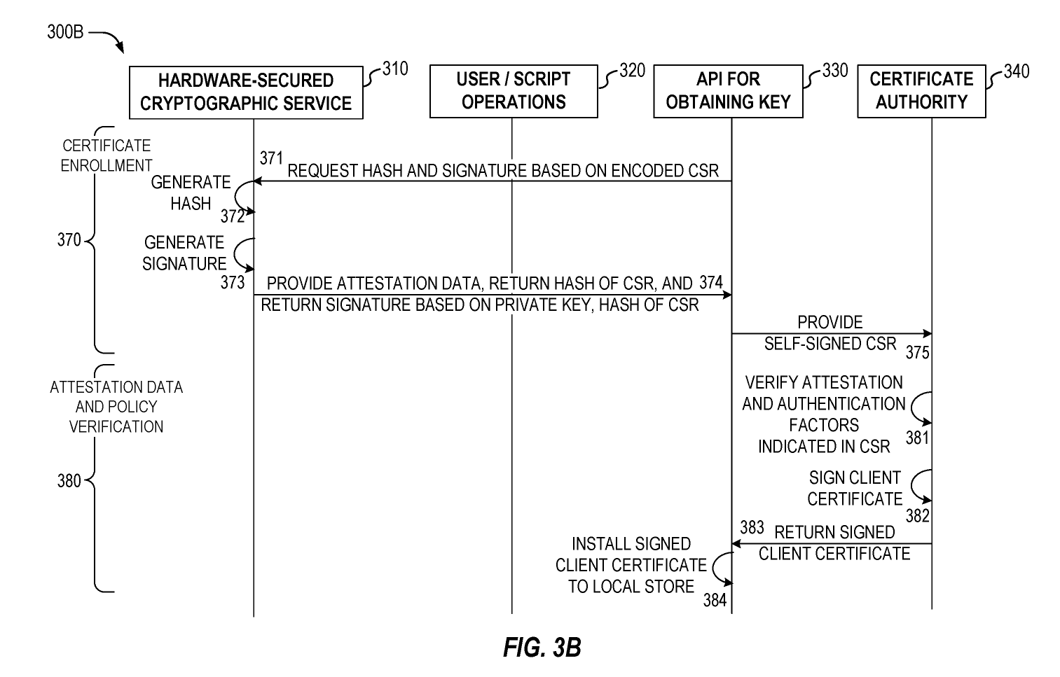

The certificate definition 160 indicates the use of an authentication policy 152A to create the signed digital certificate 162, and the signed digital certificate may be generated to include the identifier 151. This signed digital certificate 162 then may be distributed to other parties, or provided to a certificate authority as further discussed in the examples of FIGS. 3A and 3B. The private key 170A is stored in a secure data store 180 associated with the computing device 130, and is secured (e.g., via hardware) to require the use of an authentication policy 152B to access and utilize the private key 170A. By securing the private key 170A with the authentication policy 152B, everyone except the human user 110 (who the signed digital certificate 162 and for whom private key 170A was generated) is prevented from accessing and using the private key 170A—even if control of the computing device 130 or the data store 180 is somehow compromised.

As a result of the approach in FIG. 1B, the administrator 140 of the policy broker may show that the authentication policy 152B described by the signed digital certificate 162, the authentication policy 152B used to secure the private key 170A, and the policy template 150 specified by the certificate definition 160, all involve use of the same authorization factors.

As shown in FIG. 1C, an authentication factor from the user 110 in accordance with the authentication policy 152B is required to access and use the secure private key 170A. When the human user 110 attempts to access the secure private key 170A, such as in connection with a generation of a new digital signature, the human user 110 will authenticate according to the requirements of the authentication policy 152B by presenting one or more authentication factors (e.g., presentation, entry, or input of a PIN and fingerprint). Thus, the only way for the secure private key 170A to be used is to first “unlock” the secure private key 170A by inputting and verifying the one or more authentication factors 154 specified by the authentication policy 152B. When the human user 110 authenticates their identity by successfully providing the authentication factors 154, the secure private key 170B is made accessible.

Additionally, the use of the AFSI allows for the security requirements of a policy to be changed and updated without having to revoke and reissue a new private key to the user 110. For example, the signed digital certificate 162 and the private key 170A may be associated with an authorization policy that requires two types of authentication (e.g., multi-factor authentication). The signed digital certificate 162 and private key 170A each are set to a particular AFSI value (the identifier 151). In this example, if the use of the policy is intended to require three authentication methods, then the policy simply need to be updated to refer to a different AFSI value (a different identifier). The certificate and private key do not need to be revoked or changed; rather, only the policy that is effectively guarding them may be updated to indicate a new AFSI value.

As discussed in the following examples, the use of an authentication factor policy and an AFSI may be integrated with current public key infrastructures. For instance, a user or client may use an enrollment agent application to indicate they wish to enroll a new certificate according to a configuration. The user may not know the configuration, but is aware of the systems, applications, or level of security they wish to be enrolled in. The configurations or certificate templates may be pre-defined for a system, application, or security level by an administrator. Then, the user may request that a key be generated. Based on the AFSI (e.g., authentication policy) associated with the certificate definition, the user authenticates themselves with the appropriate authentication methods specified by the certificate definition. A key is created for the user by a CSP using the accompanying policy. (If the CSP is not capable of performing a policy-specified authentication, or the user does not provide that authentication, then that authentication method option may be ultimately removed from the policy that is associated with the key.)

The preceding techniques may also be accompanied with attestation, to establish that the generation of the cryptographic key has occurred according to a particular set of user authentication factors. Once a key is generated, a Certificate Signing Request (CSR) may be made, such as to a certificate authority, which indicates the range of user authentication methods available for use by the CSP and the private key. The CSP generates attestation data in response to the CSR. The attestation data attests to the successful enforcement of the user authentication factors that were used to generate the proof of possession signature. Thus, the attestation data is in effect associated with the key. When the key is used in the future, this attestation data may be used to prove that the key was generated according to a particular set of user authentication factors.

The establishment of an attestation key or keys may be performed according to the one of the following use cases:

1) The user's authentication key doubles as an attestation key. In this case, a manufacturer supplied attestation key must sign (attest) to the CA that the user authentication key is protected by a TEE for which the manufacturer-supplied key attests.

2) The user's authentication key is different from the TEE attestation key. In this case, the attestation is supplied having been signed by a manufacturer-supplied key, and a hash of the attestation value is signed by the user authentication key as part of the authentication step.

3) The user manages separate keys for authentication and attestation that both are protected by the TEE, and the CA receives attestation from the manufacturer-supplied key that this is the case. The user authentication and user attestation steps may be separable (or combined as described in use case (2)) but where the manufacturer-supplied attestation key is not used. This may avoid over-use of the manufacturer-supplied key which may have a long lifetime and may be used for tracking privacy-sensitive transactions.

The techniques described herein may be modified to permit these alternative use cases and for the possibility that the manufacturer-supplied attestation key is a unique attestation key identifier, such as an Enhanced Privacy ID (EPID). Similarly, use case (2) above may involve the use of an EPID key for the attestation key, to enable a privacy-preserving attestation key that retains the use context, such as when the attestation context is that of an employee of company-x (rather than a manufacturer) and where the issuer of the attestation key may enforce a different (e.g., shorter) lifespan to the attestation key. For example, the useful lifetime of a hardware device as designed by the manufacturer may be 10 years, while company-x may allow devices in deployment for only 4 years.

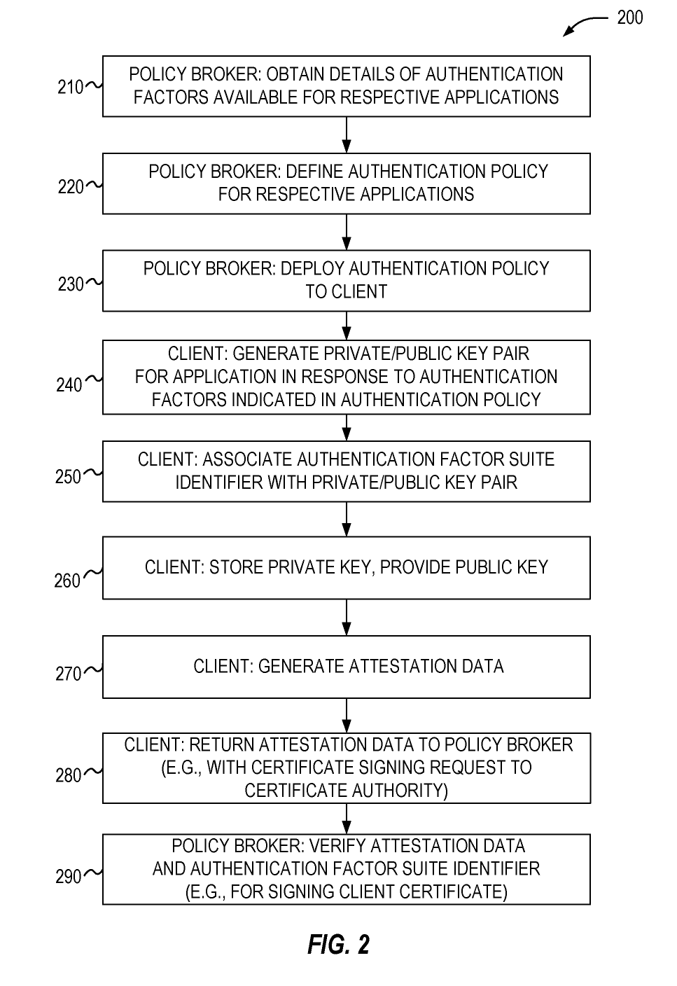

FIG. 2 illustrates a flowchart 200 of example techniques performed for establishing and deploying an authentication policy, based on an association of the authentication policy with generated authentication credentials. The following operations depicted in flowchart 200 are depicted from the perspective of operations performed by a policy broker and a client, such as in connection with the generation of a digital certificate and a certificate signing request. However, it will be understood that the following operations are also applicable to generation of other forms of credentials and cryptographic keys.

The operation of the flowchart 200 is depicted as including a policy broker (e.g., an administrator) obtaining the details of the authentication factors for the respective applications (operation 210). As an example, each application may have different levels of security requirements, and thus define different authentication factor requirements. The authentication factors may include one or more of, a password, a contextual answer, a biometric feature, a passcode, a personal identification number (PIN), or a personal security token, among other human-specific knowledge or personal factors.

The flowchart 200 further depicts the policy broker using the details obtained from operation 210 to define the authentication policy with authentication factors for the respective applications (operation 220). The policy broker defines an authentication policy by the authentication factors it will require. As an example, an authentication policy may require multiple factors, such as the combination of a password and PIN. In an example, the use of multiple factors will involve the indication of a specific AFSI for a particular authentication policy or use case. The policy broker then deploys the defined authentication policy to the client (operation 230). As suggested herein, the particular AFSI used with a policy or an application may change, or authentication values (e.g., biometric values, PINs, passwords) for the user factors may change or be established at a later time; thus, there may be some scenarios where the policy precedes entry of the factors by the user.

The flowchart 200 further depicts the client operations for generation of a cryptographic key. As shown, upon receiving a key generation request, a client operates a cryptographic service (e.g., a CSP) to generate a private and public key pair for a particular application, conditioned upon also receiving the user authentication factors indicated in the authentication policy (operation 240). The user authentication factors may be identified by a value, such as a single identifier value (e.g., an AFSI), that may be used to track and store the authentication factor characteristics used for the deployment of a particular authentication policy. The client may then associate the identifier (e.g., the AFSI) with the generated public and private key pair (operation 250). The flowchart 200 further depicts the client storing the private key on the requesting device (e.g., in secure storage) and providing the public key to the requestor (operation 260).

Additionally, the client may operate to generate data that indicates that a correct authentication policy was performed in the generation of the private key. In flowchart 200, attestation data is generated for the private key, which provides evidence of use of the authentication factors specified in the policy (operation 270).

In a specific example, a Certificate Signing Request (CSR) is constructed, with the CSR indicating a range of possible user authentication factors available to the CSP and the private key. The CSP will return the attestation data in the CSR to a policy broker (operating as a certificate authority) (operation 280), which is used to attest to successful enforcement of the authentication factors that generated the digital signature provided in the CSR. The policy broker (operating as a certificate authority) will verify the attestation data included with the CSR, based on authentication factor suite identifier (operation 290). If there are multiple policies associated with a given key, then based on additional real time attestation, the certificate authority may obtain information to indicate which particular policy was enforced.

In some examples, the signature may be used as a proof-of-possession signature, namely, that a particular device sending a message or making a request is actually in possession of the required private key. The techniques discussed herein further ensure, through the enforcement of the authentication policy, that a particular human user is also in possession of the required private key—because the key cannot be generated or used without the user authentication factors being presented from the human and verified.

Current approaches allow for limited control of how keys should be generated and protected, but one significant deficiency is that there is no proof of whether the key generation and use process actually happened according to a desired configuration. Administrators largely assume and trust clients will utilize keys correctly. However, it is possible that on the client side, a skillful but malicious user may ignore the key configurations, and have keys generated and stored as the user sees fit. This may break the believed level of control the administrators have over the process. Thus, an administrator may desire that the key generation and protection process actually happened as configured. A secure process of generating a certificate with an authentication policy, and providing proof of a properly generated certificate, is further demonstrated in FIGS. 3A and 3B.

Specifically, FIGS. 3A and 3B illustrate sequential operations performed among computing system components for the generation and attestation of authentication credentials, in compliance with authentication factors defined in an authentication policy, according to an example. The sequential operations 300A begin with the key generation operations 350. A user 320 makes a request on an electronic device to an API 330 for obtaining a key, to enroll for key generation using an authentication policy template at step 351. The template indicates the authentication factors required to enforce an authentication policy. The API obtains and parses the template for the authentication factors at step 352. A request is made to a hardware-secured cryptographic service 310 (e.g., operating in a trusted execution environment (TEE)) to generate the key pairs, in accordance with the specific authentication factors indicated by an AFSI at step 353. The authentication factors may include, a password, a contextual answer, a biometric feature, a passcode, a personal identification number (PIN), a personal security token, or other factor forms discussed herein. As discussed herein, the AFSI is a value that identifies a particular set of authentication factors for use in an authentication policy.

The cryptographic service 310 is responsible for generating the requested key pair. The cryptographic service 310 authenticates the user using the multi-factor authentication at step 354, in compliance with the defined authentication factors of the AFSI. Upon successful authentication, the cryptographic service 310 will generate the key pair (private/public key pair) at step 355. The AFSI value is associated with a keyblob for the private key at step 356. At step 357, the public key is returned to the API 330. The public key is made available to the user 320, while the encrypted private keyblob is written to the secure storage of the device.

The sequential operations 300A continue with key and certificate attestation operations 360, which create attestation data that is used to verify the performance of the multi-factor authentication with the user. The API 330 requests to open a handle to the private key to the cryptographic service 310 at step 361. The cryptographic service 310 returns the handle for the private key to the API 330 at step 362. A Certificate Signing Request (CSR) is constructed by the API 330 and contains the range of possible user authentication factors available to the cryptographic service 310 and the private key at step 363. A request for attestation data is made to the cryptographic service 310 at step 364 and includes the CSR. In a further example, steps 361 and 364 may be combined so that the request for attestation and the request for signing are atomic, thereby removing the possibility for malware that exists in the host (but not in the TEE) to manipulate an intermediate state.

Continuing the key and certificate attestation operations 360, the cryptographic service 310 will generate attestation data, attesting to successful enforcement of the authentication policy (associated with the AFSI) that was used for authentication at step 354 before the key pair generation at step 365. The attestation data is returned to the API 330 at step 366, with the attestation data being added to the CSR as an extension at step 367. The CSR is then encoded by the API 330 at step 368.

The process continues in sequential operations 300B of FIG. 3B with the certificate enrollment 370, which generates the signature for the CSR. With the encoded CSR, the API 330 makes a request to the cryptographic service 310 for a hash and a signature based on the encoded CSR at step 371. The cryptographic service 310 will generate a hash based on the CSR at step 372 and generate a signature at step 373. The hash and signature, which is based on the private key and the hash of the CSR, are returned to the API 330 at step 374; additionally, attestation data may also be communicated in step 374. This attestation data may include information about keys, policies and other values that are protected by a TEE (in addition to information about the TEE). This information corresponds to the information generated in step 365.

In an example, the CSR encoding operations occurring in step 368 may present a potential for attack code to replace the CSR content (which may include attestation values) with a CSR that omits some elements of the attestation data. This may be addressed with the communication of the attestation data in step 374, so that the cryptographic service 310 can re-attest and verify that the CSR signing request does not contain malicious CSR content (and, verify that nothing is omitted either).

The sequential operations 300B continue with the attestation data and policy verification operations 380. The API 330 makes a request to the certificate authority 340 for a signed client certificate, based on the CSR. With the attestation data, the certificate authority 340 may now verify that particular multi-factor authentication requirements specified by the AFSI were performed by the cryptographic service 310 when generating the key. At step 375, the API 330 sends the self-signed CSR (e.g. the CSR and signature returned in step 374) to the certificate authority 340. The certificate authority 340 verifies the identity of the user with the attestation data and the policy identified by the CSR at step 381. Upon successful verification, the certificate authority 340 will sign the client certificate at step 382 and return the signed client certificate to the API 330 at step 383. Finally, according to this example, with valid keys and confirmed user identity, the API 330 may install the signed client certificate to a local data store at step 384.

The use of the policy validation mechanisms as indicated in FIGS. 3A and 3B demonstrates a form of a whitelist describing a TEE and firmware, keys, polices and data protected by a TEE that can be established as part of a certificate issuance process. Further, the policy validation mechanisms demonstrate that a policy may include constraints to specify the use of the private key as being subject to a certain use of MFA, and the role of the CA is to verify that these constraints are reasonably applied. For example, the CA (e.g., as shown in step 381) may be required to witness the use of expected authentication factors as part of the signing operation (e.g., as shown in step 373). In contrast, in traditional PKI settings, a Registration Authority (RA) might require certain personnel to witness user activity. This policy validation mechanism removes the need for such activity in terms of the MFA policy.

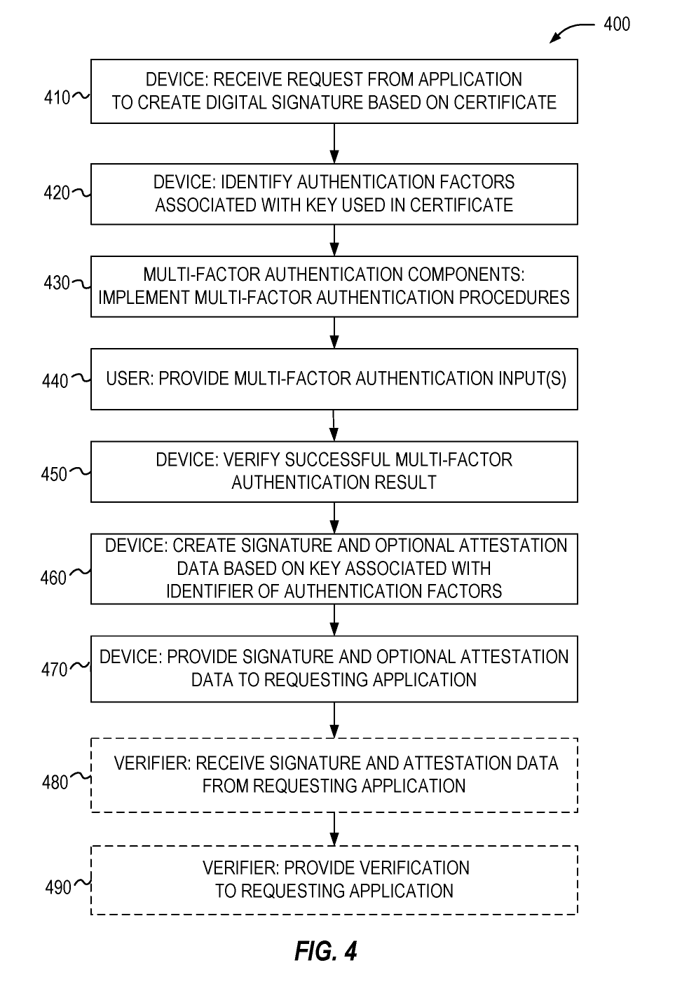

FIG. 4 illustrates a flowchart of example techniques performed for accessing and verifying authentication credentials, based on an association of the authentication policy with use of authentication credentials. The operations of flowchart 400 include an application on an electronic device making a request for a signature for a certificate and public key (operation 410). In order to receive a signature for the certificate, the private key stored in the hardware-secured cryptographic service needs to be accessed. The request is made to a CSP, which passes the request to the multi-factor authentication aware hardware-secured cryptographic service. The certificate is queried for the AFSI that identifies the authentication factors needed to access the private key (operation 420).

The flowchart 400 depicts that once the multi-factor authentication factor requirements are identified, the authentication procedures associated with the factors may be implemented (operation 430). As an example, the identifier (e.g., an AFSI) may indicate multiple factor types such as entry of a password and a biometric fingerprint scan. Based on the identified authentication factors, the user will provide (e.g., input, present) authentication input (operation 440). Continuing the example, the user will supply a password and a fingerprint scan, which are verified to match the password and fingerprint scan that were supplied when the authentication policy was created. A successful result of the multi-factor authentication is verified (operation 450).

The flowchart 400 continues with creation of a signature. With successful multi-factor authentication, the private key may be accessed to create a signature for the certificate and, if requested, include attestation data (operation 460). The digitally signed certificate, and attestation data if requested, is provided to the requesting application (operation 470). With the signed certificate and optional attestation data, the requesting application may proceed with the outside verification. By successfully accessing the private key, the user has also verified their identity as the true owner of the key. The signed certificate may be sent to the verifier, along with the attestation data (operation 480). The verifier may confirm for the application that the held certificate and keys are valid, and that the identity of the user attempting to use them conforms with the identity of the user issued the keys with the attestation data (operation 490).

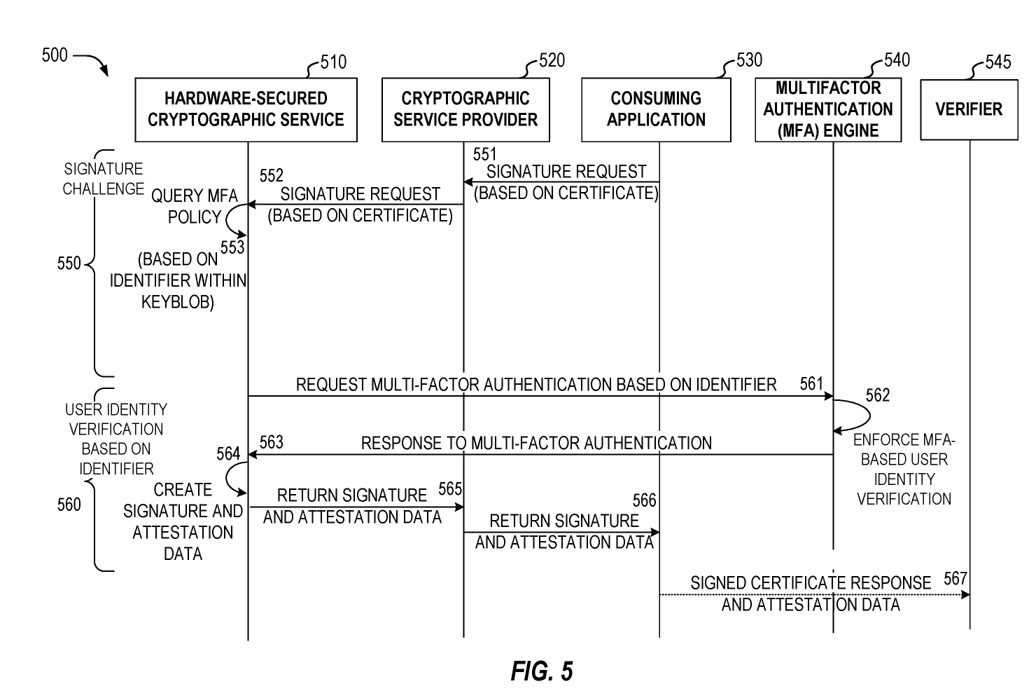

In a further example, an enrollment agent may use an API for enlightening legacy keys. For example, the process begins with the client indicate to the enrollment agent an intention of enrolling a certificate according to a certain configuration pre-defined by administrators (e.g., templates) as described above. Additionally, updated key generation operations may be performed using the new APIs calls into a CSP. The CSP authenticates the user in accordance with each authentication method specified by the template. If the CSP is not capable of performing the specified authentication, that option may be removed from the persistent policy that accompanies the key henceforth. An example of operations between an API and the CSP are further illustrated in FIG. 5 with the following description.

FIG. 5 illustrates sequential operations performed among computing system components for the use and attestation of authentication credentials, in compliance with authentication factors defined in an authentication policy, according to an example. The example sequential operations 500 begin with signature challenge operations 550, and a key generation step 551. The consuming application 530 will use a cryptographic key controlled by the cryptographic service 510 to verify itself or some data (e.g., for transmission to a verifier 545 or another entity). For example, this may be accomplished in response to a request by the consuming application 530 to a cryptographic service 510 to digitally sign a copy of some data. As discussed herein, the consuming application 530 uses a CA-signed digital certificate, and an accompanying authentication policy, to retrieve and use a private key that creates a digital signature.

To access the private key and obtain the signature, the consuming application 530 makes a request to a CSP 520 for a signature based on the provided digital certificate at step 551, which then provides the request to the hardware-secured cryptographic service 510 at step 552. The certificate is queried for the authentication policy identification value (e.g., AFSI) that identifies the user authentication factors of the authentication policy needed to access the private key at step 553.

The example sequential operations 500 continue with the user identity verification operations 560 based on the identifier (e.g., the AFSI). Based on the authentication policy identification value, the specific user authentication factors associated with the authentication policy must be implemented to access the private key. At step 561 a request is made to the MFA engine 540 to verify the identity of the user based on the user authentication factors. The MFA engine 540 enforces the user authentication factors associated with the authentication policy to verify the identity of the user at step 562. As an example, the authentication policy may require use of multiple authentication factors such as a combination of a password and PIN. In such an example, the user is required to supply a password and a PIN that match the password and PIN enrolled into the device. The MFA engine 540 will provide a response to the cryptographic service 510 at step 563 with the results of the user identity verification.

Continuing the sequential operations 500, if the cryptographic service 510 receives a successful user identity verification from the MFA engine 540, then at step 564, the private key may be used to create a signature for the certificate in step 562. Additionally, attestation data may be created to confirm the user identity verification performed with the MFA engine 540. The digital certificate and attestation data may now be returned to the consuming application 530 by way of the CSP 520 in steps 565 and 566. The application 530 may now use the digital signature to verify itself or its data, which was generated according to the multi-factor authentication requirements. Additionally, the application 530 may provide a response to the verifier 545 that includes the digital signature (and optionally, attestation data) at step 567.

The previous examples provided discussion related to the use of digital certificates and public-private keys. However, it will be understood that the following techniques may be used in any number of settings and algorithms (including with the use of symmetric ciphers). Other implementation examples are suggested by the following examples.

X.509 Certificates.

In an example, a use of X.509 standard operations may involve the application of RSA, DSA, or other algorithms, for secure data transmissions. The authentication techniques discussed herein may enable a private key to be made identity-aware or any key usages (e.g. dataEncipherment, codeSigning, etc.) that use a private key to involve multi-factor authentication with the user.

SSH/SFTP.

In another example, a use of SSH or SFTP may involve the application of RSA or other algorithms for secure data transmissions. The authentication techniques discussed herein may enable a private key to be made identity aware. The authentication techniques discussed herein may also enable the SSH or SFTP login to be protected by multi-factor authentication and offer better protection to critical servers and repositories.

File Encryption.

In another example, a use of file encryption, such as with a synchronized file sharing service or API, may involve the application of AES or other algorithms for secure encryption. The authentication techniques discussed herein may enable a symmetric key to be made identity-aware and for the encryption and decryption of protected files to require multi-factor authentication.

SSL/TLS Ciphers.

In another example, a use of SSL/TLS ciphers, occurring post-handshake, may involve the application of AES, Camellia, ARIA, 3DES, or other algorithms for secure encryption. The authentication techniques discussed herein may enable a symmetric key to made identity aware and for the encryption and decryption of session data to require multi-factor authentication.

HTML 5 Web Storage.

In another example, a use of HTML 5 Web Storage, such as storing JSON Web Tokens, may involve the application of WebCrypto APIs or other algorithms for token encryption. The authentication techniques discussed herein may enable the key used to protect the authentication tokens to be made identity aware. This may enable multi-factor authentication to access tokens, offering re-authentication with JavaScript Web Apps.

Blockchain.

In another example, blockchain, a typically-distributed database of ordered and linked records, may involve the use of a key produced from the techniques discussed herein. Specifically, an asymmetric key (a public key) is used for entering a transaction into the blockchain, but based on the key alone, it would not be known if the key is actually backed by a particular human. Integrating multi-factor authentication into the generation or use of a key provided for a transaction in a blockchain entry may ensure the identity of the user holding the key and making the transaction.

The preceding policy and user authentication factor techniques may be used to provide authentication policies for the level required by an application's purpose, while providing users with flexibility to access other applications. As an example, a distributed system of applications may include some applications with very sensitive data and require a high level of security, but there are also other applications, which do not contain sensitive data, and thus the needed level security is minimal. The high security applications may be specified with an AFSI to require a password, PIN, and biometric fingerprint scan, while the low security applications may be specified with an AFSI to only enter a password.

Further, the preceding policy and user authentication factor techniques may be used to tie a user's identity with the key from point of issuance. As a result, each time the user attempts to use the key, their personal authorization may be required to ensure the identity of the user using the key is the same as the user who was issued the key.

Moreover, use of the preceding policy and user authentication factor techniques in connection with a certificate enrollment, enable the certificate authority to act as the gatekeeper, using a specified policy, for a proof-of-possession signature. Essentially, the certificate enrollment request and response includes the user authentication requirements specified by the user authentication policy. This ensures that not only the keys are protected, but the keys are also tied with a user identity and purpose since the creation of the keys. Thus, the certificate authority may effectively bind a user authentication policy with the certificate such that, a CSP will enforce the certified user authentication policy. A verifier may be assured by the CSP and CA that the certified policy is the same one used when the private key signing operation was applied.

In a similar fashion, a blockchain ‘miner’ may establish the security properties of the key (as described above), but such a ‘miner’ may also enlist the consensus truth of peer miners who in essence act as peer CAs performing the same enrollment steps. The assertion of trust normally ascribed to a single CA thus may be shared across a network of blockchain peers that have agreed to consensus truth regarding the assertions of trust. Accordingly, in further examples, the CA may facilitate the issuance of a certificate whose trust is backed by a blockchain.

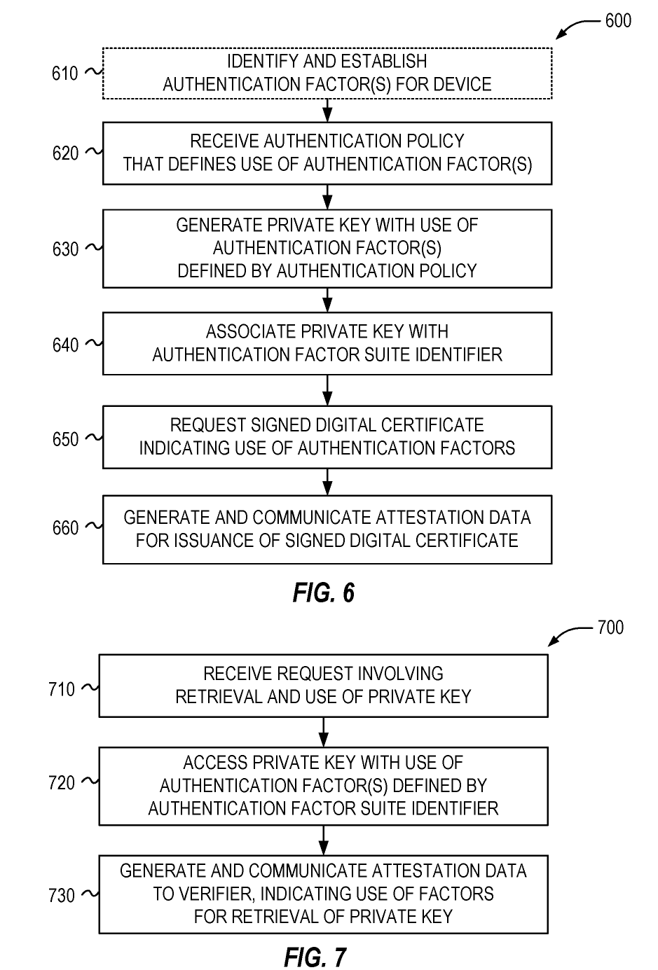

FIG. 6 is a flowchart 600 illustrating an example method of performing cryptographic operations including generation of a cryptographic key according an authentication factor policy. The following operations of the flowchart 600 may be conducted by an electronic processing device (including a specialized computing system, including but not limited to a personal computer, mobile computing device, or other client computing system) adapted to perform cryptographic operations based on an authentication policy. It will be understood that the operations of the flowchart 600 may also be performed by other devices or a combination of devices, with the sequence and type of operations of the flowchart 600 potentially modified based on the other examples of verification, validation, attestation, and the like, provided above.

The operations of the flowchart 600 include device operations that identify and establish (e.g., enroll) one or more authentication factors for a device (operation 610). In an example, the establishment may include the enrollment and definition of a user authentication factor (or multiple authentication factors), by human user input, from some combination of: a password, a contextual answer, a biometric feature, a voice signature, a passcode, a personal identification number (PIN), user location information, a personal security token, or information to determine such values.

The operations of the flowchart 600 continue with the receipt of an authentication policy that defines the use of the one or more authentication factors (operation 620). Specifically, the authentication policy may define a requirement for the receipt of a user authentication factor in order to generate or to retrieve a cryptographic key, including application-unique requirements for respective software applications operating on the computing device. In response to receipt and verification of the input of the one or more user authentication factors that are required by the authentication policy, a cryptographic key (e.g., a private key) is generated (operation 630). In a further example, a public value (e.g., public key) derived from the cryptographic key is also generated. In a further example, a hardware-secured cryptographic service on the device operates to generate and secure the cryptographic key. In a further example, a CSP operates on the device to coordinate the issuance of the cryptographic key.

Operations for establishing and verifying of the key may include the association of the cryptographic key with an authentication policy identifier (operation 640), such as may be performed in connection with secure (e.g., hardware-protected) storage of the private cryptographic, inclusion of the authentication policy identifier in a digital certificate, and the like. In examples involving the generation of a digital certificate, the device further operates to request a signed digital certificate from a certificate authority that indicates use of the authentication policy (operation 650), such as may be provided with the inclusion of the authentication policy identifier in a client certificate. Additionally, attestation data that is generated in connection with the generation of the private key may be communicated with the request for the signed digital certificate (operation 660). This attestation data should be designed to satisfy the need that the CA has of verifying that the authentication policy is followed by the user during enrollment. This allows a certificate authority or other verifier to confirm that a particular user authentication policy (and a set of user authentication factors specified by the particular user authentication policy) were performed for the generation of the key and the request for the signed digital certificate.

In a blockchain scenario, the peer ‘miners’ also must perform a similar verification of user authentication policy compliance. Pragmatically, this may occur over a period of time. For example, each time the user performs an authentication operation where a MFA policy is followed, the verifier can act as a blockchain miner that contributes to consensus truth. When a majority of miners is reached, a new certificate may be issued that possesses this higher level of trust assertion.

In a further example, the requirement for presentation of the user authentication factor is enforced by a hardware-secured cryptographic service of the computing device, which then permits the respective operations to generate and retrieve the cryptographic key. Also in a further example, the authentication policy defines different requirements for software applications. For example, a first software application and may involve use of a first user authentication factor, whereas a second user authentication factor may involve use of a second authentication factor.

FIG. 7 is a flowchart 700 illustrating an example method of performing cryptographic operations including accessing a cryptographic key according an authentication factor policy. Similar to the discussion provided above with reference to FIG. 6, the following operations of the flowchart 700 may be conducted by an electronic processing device (e.g., a computing device) or combinations of such devices.

As shown, a device may receive a request (e.g., a request from a legacy software application) for a retrieval and use of a private key (operation 710). This may occur, in some examples, as a result of a signature request from an application to generate a digital signature or public key with use of a cryptographic service provider. In some examples, this request is accompanied by a certificate (e.g., a CA-signed client certificate) that is trusted by a requesting application. In response to the request for retrieval and use of the private key, and in response to successful authentication with the defined user authentication factors, the private key is accessed from a secure storage location (operation 720). The association between the one or more defined user authentication factors and the particular private key may be established by an identifier of the policy that is specified in the supplied certificate. The private key may be used to generate a digital signature, a signed certificate response, decrypt data, verify data, or like operations.

In further examples, attestation data may be generated and communicated, as a result of successful user authentication factor requirements involved in retrieval and use of the private key (operation 730). This may involve transmitting attestation data to a verifier, which confirms the receipt of the user authentication factor to access the cryptographic key. This attestation data may include an indication of the identifier assigned to the authentication policy. As a result, a verifier that is associated with the application (e.g., a creator or service provider of the application) may validate the digital signature that was created using the private key, and validate that the digital signature was created with use of the same multi-factor authentications policy verified by the certificate authority. In a further example, the verifier may select among several certificates having different levels of trust. A local policy may require the verifier select a certificate with a higher level of trust assertion, for example, one established using a blockchain.

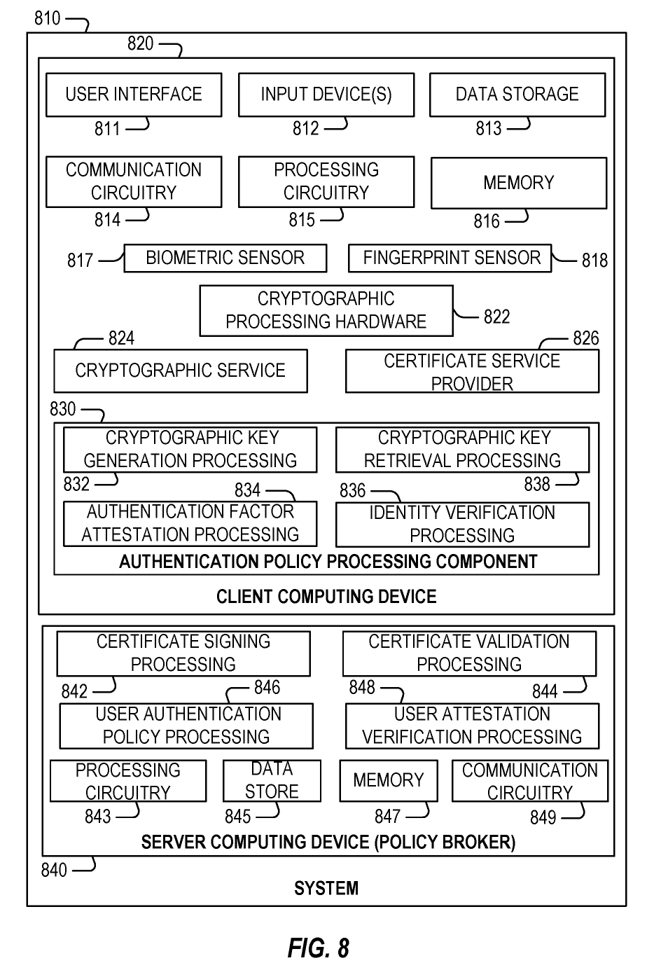

FIG. 8 illustrates a block diagram of components in an example system 810 configured for implementing the techniques described herein. As shown, the block diagram depicts a client computing device 820 and server computing device 840 that includes various electronic processing components (e.g., circuitry) to perform cryptographic operations based on an authentication policy. It will be understood that additional electronic input, output, and processing components may be added within the system 810, and that additional processing systems (such as external computing devices and systems) may be used in connection with the authentication generation, processing, verification, and use operations described herein.

As shown, the client computing device 820 includes electronic components (e.g., circuitry) provided by an authentication policy processing component 830 in addition to respective components 811-826. Other electronic components may be added or integrated within the client computing device 820; likewise, other electronic components and subsystems from other devices (e.g., external devices) may be utilized for the operation of the system 810.

As an example, the hardware components of the client computing device 820 may include: circuitry to implement a user interface 811, e.g., to output an interactive display via a display output or another user interface hardware device to control and interact with authentication operations or entry of the authentication data; input devices 812 to provide human input and interaction including the control of authentication operations; data storage 813 to store authentication data, policies, rules, and instructions for operation of the authentication policy processing component 830 and other components of the client computing device 820; communication circuitry 814 to communicate data (e.g., wired and wirelessly) with other computing systems and devices, including networked service providers, policy brokers, certificate authorities, and the like; and processing circuitry 815 (e.g., a CPU) and a memory 816 (e.g., volatile or non-volatile memory) used to host and process the operations and control instructions for operation of the client computing device 820.

The client computing device 820 is further depicted as including specialized hardware components for use with authentication and cryptographic operations, including: a biometric sensor 817 to capture or process biometric information from physiological characteristics of a human; a fingerprint sensor 818 to capture or process a fingerprint biometric of a human; cryptographic processing hardware 822 which may be used to generate and control cryptographic operations; a cryptographic service 824 implemented in the computing system (e.g., via instructions) to offer the cryptographic operations to an operating system and consuming software applications; and a certificate service provider 826 implemented in the computing system to manage, control, and access digital certificate operations. It will be understood that more or fewer sensors and cryptographic processing components may also be used, depending on the capabilities of the device or the particular authentication use case.

The client computing device 820 is further depicted as including processing features located among the authentication policy processing component 830, which, may be provided by processing components for: cryptographic key generation processing 832 (e.g., to generate a key in accordance with a authentication policy, such as depicted in the examples of FIG. 2 and FIGS. 3A and 3B), cryptographic key retrieval processing 838 (e.g., to retrieve and use a key in accordance with a authentication policy, such as depicted in the examples of FIGS. 4 and 5), authentication factor attestation processing 834 (e.g., to perform the generation or validation of attestation data in connection with use of a authentication policy), and identity verification processing 836 (e.g., to perform, enable, or deny certain operations in connection with specific forms of user authentication factor enrollments such as password and PIN values, biometric values, and the like). In an example, the authentication policy processing component 830 may be provided from specialized hardware operating independent from the processing circuitry 815 and the memory 816; in other examples, the authentication policy processing component 830 may be software-configured hardware that is implemented with use of the processing circuitry 815 and the memory 816 (e.g., by instructions executed by the processing circuitry 815 and the memory 816).

The system 810 is further depicted as including a server computing device 840, such as may be implemented by a computing system operating as a policy broker, certificate authority, or the like. The server computing device 840 may include processing circuitry 843 (e.g., a CPU), a data store 845 (e.g., a storage device), a memory 847 (e.g., volatile or non-volatile memory), communication circuitry 849 (e.g., wired or wireless communications hardware). The server computing device 840 may also include processing features located among: a certificate signing processing 842 (e.g., to generate and sign a client certificate), certificate validation processing 844 (e.g., to validate or serve data in connection with certificates and signatures), user authentication policy processing 846 (e.g., to verify or serve data in connection with a particular user, device, or identifier), and user attestation processing 848 (e.g., to validate user attestation data being provided as a result of use or generation of a multi-factor authentication policy).

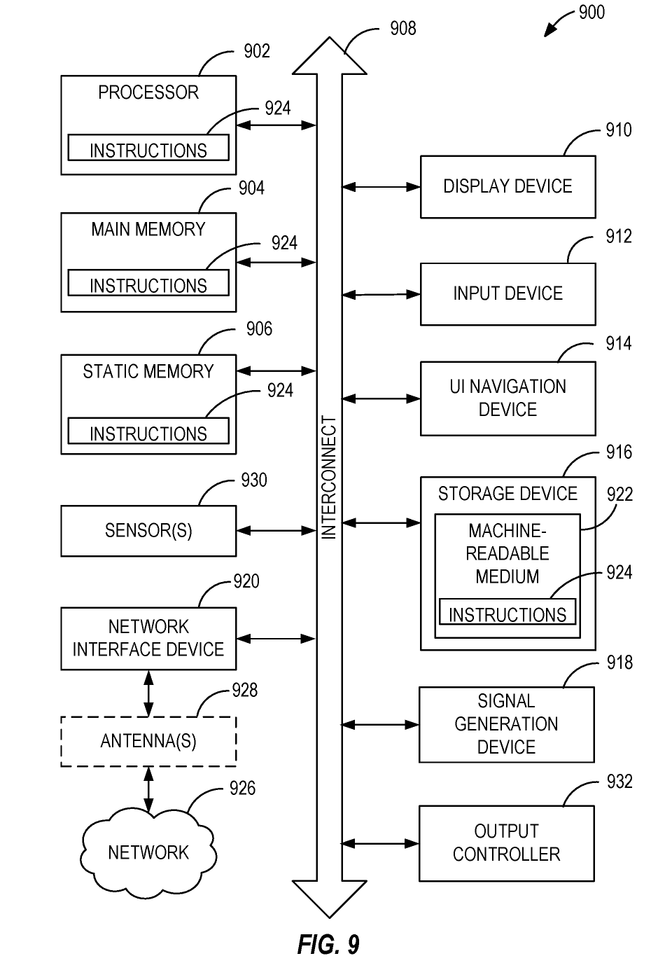

FIG. 9 is a block diagram illustrating a machine in the example form of an electronic processing system 900, within which a set or sequence of instructions may be executed to cause the machine to perform any one of the methodologies discussed herein, according to an example embodiment. The machine may be a standalone virtual reality display system or component, a personal computer (PC), a tablet PC, a personal digital assistant (PDA), a mobile telephone or smartphone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example electronic processing system 900 includes at least one processor 902 (e.g., a central processing unit (CPU), a graphics processing unit (GPU) or both, processor cores, compute nodes, etc.), a main memory 904 and a static memory 906, which communicate with each other via an interconnect 908 (e.g., a link, a bus, etc.). The electronic processing system 900 may further include a video display unit 910, an input device 912 (e.g., an alphanumeric keyboard), and a user interface (UI) control device 914 (e.g., a mouse, button controls, etc.). In one embodiment, the video display unit 910, input device 912 and UI navigation device 914 are incorporated into a touch screen display. The electronic processing system 900 may additionally include a storage device 916 (e.g., a drive unit), a signal generation device 918 (e.g., a speaker), an output controller 932 (e.g., for control of actuators, motors, and the like), a network interface device 920 (which may include or operably communicate with one or more antennas 930, transceivers, or other wireless communications hardware), and one or more sensors 926 (e.g., cameras), such as a global positioning system (GPS) sensor, compass, accelerometer, location sensor, or other sensor.

The storage device 916 includes a machine-readable medium 922 on which is stored one or more sets of data structures and instructions 924 (e.g., software) embodying or utilized by any one or more of the methodologies or functions described herein. The instructions 924 may also reside, completely or at least partially, within the main memory 904, static memory 906, and/or within the processor 902 during execution thereof by the electronic processing system 900, with the main memory 904, static memory 906, and the processor 902 also constituting machine-readable media.

While the machine-readable medium 922 is illustrated in an example embodiment to be a single medium, the term “machine-readable medium” may include a single medium or multiple media (e.g., a centralized or distributed database, and/or associated caches and servers) that store the one or more instructions 924. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and optical disks.

The instructions 924 may further be transmitted or received over a communications network 928 using a transmission medium via the network interface device 920 utilizing any one of a number of transfer protocols (e.g., HTTP). The term “transmission medium” shall be taken to include any intangible medium that is capable of storing, encoding, or carrying instructions for execution by the machine, and includes digital or analog communications signals or other intangible medium to facilitate communication of such software. Examples of communication networks include a local area network (LAN), a wide area network (WAN), the Internet, mobile telephone networks, plain old telephone (POTS) networks, and wide-area, local-area, and personal-area wireless data networks (e.g., Wi-Fi, Bluetooth, 2G/3G, or 4G LTE/LTE-A networks or network connections). Further, the network interface device 920 may perform other data communication operations using these or any other like forms of transfer protocols.

Embodiments used to facilitate and perform the techniques described herein may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

It should be understood that the functional units or capabilities described in this specification may have been referred to or labeled as components or modules, in order to more particularly emphasize their implementation independence. Such components may be embodied by any number of software or hardware forms. For example, a component or module may be implemented as a hardware circuit comprising custom very-large-scale integration (VLSI) circuits or gate arrays, off-the-shelf semiconductors such as logic chips, transistors, or other discrete components. A component or module may also be implemented in programmable hardware devices such as field programmable gate arrays, programmable array logic, programmable logic devices, or the like. Components or modules may also be implemented in software for execution by various types of processors. An identified component or module of executable code may, for instance, comprise one or more physical or logical blocks of computer instructions, which may, for instance, be organized as an object, procedure, or function. Nevertheless, the executables of an identified component or module need not be physically located together, but may comprise disparate instructions stored in different locations which, when joined logically together, comprise the component or module and achieve the stated purpose for the component or module.

Indeed, a component or module of executable code may be a single instruction, or many instructions, and may even be distributed over several different code segments, among different programs, and across several memory devices or processing systems. In particular, some aspects of the described process may take place on a different processing system (e.g., in an external computing device), than that in which input data is collected or the code is deployed. Similarly, operational data may be identified and illustrated herein within components or modules, and may be embodied in any suitable form and organized within any suitable type of data structure. The operational data may be collected as a single data set, or may be distributed over different locations including over different storage devices, and may exist, at least partially, merely as electronic signals on a system or network. The components or modules may be passive or active, including agents operable to perform desired functions.

Additional examples of the presently described method, system, and device embodiments include the following, non-limiting configurations. Each of the following non-limiting examples may stand on its own, or may be combined in any permutation or combination with any one or more of the other examples provided below or throughout the present disclosure.

Example 1 is a computing device to perform cryptographic operations based on an authentication policy, the computing device comprising processing circuitry to: receive an authentication policy from a policy broker, wherein the authentication policy defines a requirement of a user authentication factor to generate and retrieve a cryptographic key; generate the cryptographic key in response to receipt of the user authentication factor defined by the authentication policy; generate attestation data, wherein the attestation data indicates generation of the cryptographic key in compliance with the authentication policy; and communicate the attestation data to the policy broker, wherein the attestation data is validated by the policy broker to verify generation of the cryptographic key in compliance with the authentication policy.

In Example 2, the subject matter of Example 1 optionally includes wherein the authentication policy specifies use of at least one user authentication factor including: a password, a contextual answer, a biometric feature, a voice signature, a passcode, a personal identification number (PIN), user location information, or a personal security token, and wherein the user authentication factor is provided by a human user via input to the computing device.

In Example 3, the subject matter of Example 2 optionally includes wherein operations to generate the cryptographic key are further performed in response to receipt and verification of the input of the user authentication factor, the receipt and verification of the input of the user authentication factor performed by the computing device.

In Example 4, the subject matter of any one or more of Examples 2-3 optionally include wherein the requirement of the user authentication factor is enforced by a hardware-secured cryptographic service of the computing device in respective operations to generate and retrieve the cryptographic key.

In Example 5, the subject matter of any one or more of Examples 2-4 optionally include the processing circuitry further to: establish a plurality of user authentication factors on the computing device prior to generation of the cryptographic key; and wherein the authentication policy defines a requirement of multi-factor authentication to generate and retrieve the cryptographic key, wherein the multi-factor authentication includes the user authentication factor and a second user authentication factor, and wherein the plurality of user authentication factors established on the computing device are used with the multi-factor authentication.

In Example 6, the subject matter of Example 5 optionally includes wherein an identification of the plurality of user authentication factors established on the computing device are communicated to the policy broker, and wherein the authentication policy indicates respective user authentication factors for use in a plurality of software applications to execute on the computing device.

In Example 7, the subject matter of any one or more of Examples 1-6 optionally include wherein the authentication policy defines respective requirements for at least a first software application and a second software application to execute on the computing device, and wherein the authentication policy defines use of a first user authentication factor for the first software application and use of a second user authentication factor for the second software application.

In Example 8, the subject matter of any one or more of Examples 1-7 optionally include wherein the authentication policy is associated with an identifier, and wherein the attestation data indicates compliance with the authentication policy based on the identifier.

In Example 9, the subject matter of any one or more of Examples 1-8 optionally include wherein the attestation data is generated based on one or more of: manufacturer information, software or firmware executing inside a trusted execution environment, data protected by the trusted execution environment, at least one key protected by the trusted execution environment, or use of a blockchain technique.

In Example 10, the subject matter of any one or more of Examples 1-9 optionally include wherein the authentication policy is updated, by the policy broker, subsequent to generation of the cryptographic key, wherein the authentication policy is updated to change the requirement of the user authentication factor to subsequently retrieve the cryptographic key.

In Example 11, the subject matter of any one or more of Examples 1-10 optionally include the processing circuitry further to: receive a request to access the cryptographic key from a data store; and access the cryptographic key in response to receipt of the user authentication factor defined by the authentication policy.

In Example 12, the subject matter of any one or more of Examples 1-11 optionally include the processing circuitry further to: transmit, to a verifier, second attestation data to indicate the receipt of the user authentication factor to access the cryptographic key, wherein the second attestation data indicates compliance with the authentication policy based on an identifier associated with the authentication policy.

In Example 13, the subject matter of Example 12 optionally includes wherein a first value is input by a human user to the computing device for performance of the user authentication factor to generate the cryptographic key, wherein the first value differs from a second value that is input by the human user to the computing device for performance of the user authentication factor to access the cryptographic key.

In Example 14, the subject matter of any one or more of Examples 1-13 optionally include the processing circuitry further to: create a certificate signing request to transmit to the policy broker, wherein the cryptographic key is a private key used to sign the certificate signing request, wherein the certificate signing request includes a public key corresponding to the private key, and wherein the policy broker is a certificate authority.

In Example 15, the subject matter of Example 14 optionally includes the processing circuitry further to: receive, from the policy broker in response to the certificate signing request, a signed client certificate, wherein the signed client certificate indicates an identifier of the authentication policy.

In Example 16, the subject matter of any one or more of Examples 1-15 optionally include the cryptographic key being generated for use in a digitally signed certificate in an X.509 certification procedure.

In Example 17, the subject matter of any one or more of Examples 1-16 optionally include wherein the cryptographic key is generated for use as: a Secure Shell (SSH) private key, a Secure File Transfer Protocol (SFTP) private key, a file encryption private key, a Secure Sockets Layer (SSL) cipher, a Transport Layer Security (TLS) cipher, a JavaScript-based application programming interface (API) authentication token, or a blockchain asymmetric key.

Example 18 is at least one machine readable storage medium, comprising a plurality of instructions adapted to perform cryptographic operations based on an authentication policy, wherein the instructions, responsive to being executed with processor circuitry of a computing device, cause the computing device to: receive an authentication policy from a policy broker, wherein the authentication policy defines a requirement of a user authentication factor to generate and retrieve a cryptographic key; generate the cryptographic key in response to provision of the user authentication factor defined by the authentication policy; generate attestation data, wherein the attestation data indicates generation of the cryptographic key in compliance with the authentication policy; and communicate the attestation data to the policy broker, wherein the attestation data is validated by the policy broker to verify generation of the cryptographic key in compliance with the authentication policy.

In Example 19, the subject matter of Example 18 optionally includes wherein the authentication policy specifies use of at least one user authentication factor including: a password, a contextual answer, a biometric feature, a voice signature, a passcode, a personal identification number (PIN), user location information, or a personal security token, and wherein the user authentication factor is provided by a human user via input to the computing device.

In Example 20, the subject matter of Example 19 optionally includes wherein operations to generate the cryptographic key are further performed in response to receipt and verification of the input of the user authentication factor, the receipt and verification of the input of the user authentication factor performed by the computing device.

In Example 21, the subject matter of any one or more of Examples 19-20 optionally include wherein the requirement of the user authentication factor is enforced by a hardware-secured cryptographic service of the computing device in respective operations to generate and retrieve the cryptographic key.

In Example 22, the subject matter of any one or more of Examples 19-21 optionally include wherein the instructions further cause the computing device to: establish a plurality of user authentication factors on the computing device, prior to generation of the cryptographic key; and wherein the authentication policy defines a requirement of multi-factor authentication to generate and retrieve the cryptographic key, wherein the multi-factor authentication includes the user authentication factor and a second user authentication factor, and wherein the plurality of user authentication factors established on the computing device are used with the multi-factor authentication.

In Example 23, the subject matter of Example 22 optionally includes wherein an identification of the plurality of user authentication factors established on the computing device are communicated to the policy broker, and wherein the authentication policy indicates respective user authentication factors for use in a plurality of software applications to execute on the computing device.

In Example 24, the subject matter of any one or more of Examples 18-23 optionally include wherein the authentication policy defines respective requirements for at least a first software application and a second software application to execute on the computing device, and wherein the authentication policy defines use of a first user authentication factor for the first software application and use of a second user authentication factor for the second software application.

In Example 25, the subject matter of any one or more of Examples 18-24 optionally include wherein the authentication policy is associated with an identifier, and wherein the attestation data indicates compliance with the authentication policy based on the identifier.

In Example 26, the subject matter of any one or more of Examples 18-25 optionally include wherein the attestation data is generated based on one or more of: manufacturer information, software or firmware executing inside a trusted execution environment, data protected by the trusted execution environment, at least one key protected by the trusted execution environment, or use of a blockchain technique.

In Example 27, the subject matter of any one or more of Examples 18-26 optionally include wherein the authentication policy is updated, by the policy broker, subsequent to generation of the cryptographic key, wherein the authentication policy is updated to change the requirement of the user authentication factor to subsequently retrieve the cryptographic key.

In Example 28, the subject matter of any one or more of Examples 18-27 optionally include wherein the instructions further cause the computing device to: receive a request to access the cryptographic key from a data store; and access the cryptographic key in response to receipt of the user authentication factor defined by the authentication policy.

In Example 29, the subject matter of Example 28 optionally includes wherein the instructions further cause the computing device to: transmit, to a verifier, second attestation data to indicate the receipt of the user authentication factor to access the cryptographic key, wherein the second attestation data indicates compliance with the authentication policy based on an identifier associated with the authentication policy.

In Example 30, the subject matter of Example 29 optionally includes wherein a first value is input by a human user to the computing device for performance of the user authentication factor to generate the cryptographic key, wherein the first value differs from a second value that is input by the human user to the computing device for performance of the user authentication factor to access the cryptographic key.

In Example 31, the subject matter of any one or more of Examples 18-30 optionally include wherein the instructions further cause the computing device to: create a certificate signing request to transmit to the policy broker, wherein the cryptographic key is a private key used to sign the certificate signing request, wherein the certificate signing request includes a public key corresponding to the private key, and wherein the policy broker is a certificate authority.

In Example 32, the subject matter of Example 31 optionally includes wherein the instructions further cause the computing device to: receive, from the policy broker in response to the certificate signing request, a signed client certificate, wherein the signed client certificate indicates an identifier of the authentication policy.

In Example 33, the subject matter of any one or more of Examples 18-32 optionally include the cryptographic key being generated for use in a digitally signed certificate in an X.509 certification procedure.

In Example 34, the subject matter of any one or more of Examples 18-33 optionally include wherein the cryptographic key is generated for use as: a Secure Shell (SSH) private key, a Secure File Transfer Protocol (SFTP) private key, a file encryption private key, a Secure Sockets Layer (SSL) cipher, a Transport Layer Security (TLS) cipher, a JavaScript-based application programming interface (API) authentication token, or a blockchain asymmetric key.

Example 35 is a method to perform cryptographic operations based on an authentication policy, the method comprising electronic operations performed with a computing device, including: receiving an authentication policy from a policy broker, the authentication policy defining a requirement of a user authentication factor to generate and retrieve a cryptographic key; generating the cryptographic key in response to receipt of the user authentication factor defined by the authentication policy; generating attestation data, wherein the attestation data indicates generation of the cryptographic key in compliance with the authentication policy; and communicating the attestation data to the policy broker, wherein the attestation data is validated by the policy broker to verify generation of the cryptographic key in compliance with the authentication policy.

In Example 36, the subject matter of Example 35 optionally includes wherein the authentication policy specifies use of at least one user authentication factor including: a password, a contextual answer, a biometric feature, a voice signature, a passcode, a personal identification number (PIN), user location information, or a personal security token, and wherein the user authentication factor is provided by a human user via input to the computing device.

In Example 37, the subject matter of Example 36 optionally includes wherein operations to generate the cryptographic key are further performed in response to receipt and verification of the input of the user authentication factor, the receipt and verification of the input of the user authentication factor performed by the computing device.

In Example 38, the subject matter of any one or more of Examples 36-37 optionally include wherein the requirement of the user authentication factor is enforced by a hardware-secured cryptographic service of the computing device in respective operations to generate and retrieve the cryptographic key.

In Example 39, the subject matter of any one or more of Examples 36-38 optionally include the electronic operations further including: establishing a plurality of user authentication factors on the computing device, prior to generation of the cryptographic key; and wherein the authentication policy defines a requirement of multi-factor authentication to generate and retrieve the cryptographic key, wherein the multi-factor authentication includes the user authentication factor and a second user authentication factor, and wherein the plurality of user authentication factors established on the computing device are used with the multi-factor authentication.

In Example 40, the subject matter of Example 39 optionally includes wherein an identification of the plurality of user authentication factors established on the computing device are communicated to the policy broker, and wherein the authentication policy indicates respective user authentication factors for use in a plurality of software applications to execute on the computing device.

In Example 41, the subject matter of any one or more of Examples 36-40 optionally include wherein the authentication policy defines respective requirements for at least a first software application and a second software application to execute on the computing device, and wherein the authentication policy defines use of a first user authentication factor for the first software application and use of a second user authentication factor for the second software application.

In Example 42, the subject matter of any one or more of Examples 36-41 optionally include wherein the authentication policy is associated with an identifier, and wherein the attestation data indicates compliance with the authentication policy based on the identifier.

In Example 43, the subject matter of any one or more of Examples 36-42 optionally include wherein the attestation data is generated based on one or more of: manufacturer information, software or firmware executing inside a trusted execution environment, data protected by the trusted execution environment, at least one key protected by the trusted execution environment, or use of a blockchain technique.

In Example 44, the subject matter of any one or more of Examples 36-43 optionally include wherein the authentication policy is updated, by the policy broker, subsequent to generation of the cryptographic key, wherein the authentication policy is updated to change the requirement of the user authentication factor to subsequently retrieve the cryptographic key.

In Example 45, the subject matter of any one or more of Examples 36-44 optionally include the electronic operations further including: receiving a request to access the cryptographic key from a data store; and accessing the cryptographic key in response to receipt of the user authentication factor defined by the authentication policy.

In Example 46, the subject matter of Example 45 optionally includes the electronic operations further including: transmitting, to a verifier, second attestation data to indicate the receipt of the user authentication factor to access the cryptographic key, wherein the second attestation data indicates compliance with the authentication policy based on an identifier associated with the authentication policy.

In Example 47, the subject matter of Example 46 optionally includes wherein a first value is input by a human user to the computing device for performance of the user authentication factor to generate the cryptographic key, wherein the first value differs from a second value that is input by the human user to the computing device for performance of the user authentication factor to access the cryptographic key.

In Example 48, the subject matter of any one or more of Examples 36-47 optionally include the electronic operations further including: creating a certificate signing request to transmit to the policy broker, wherein the cryptographic key is a private key used to sign the certificate signing request, wherein the certificate signing request includes a public key corresponding to the private key, and wherein the policy broker is a certificate authority.

In Example 49, the subject matter of Example 48 optionally includes the electronic operations further including: receiving, from the policy broker in response to the certificate signing request, a signed client certificate, wherein the signed client certificate indicates an identifier of the authentication policy.

In Example 50, the subject matter of any one or more of Examples 36-49 optionally include the cryptographic key being generated for use in a digitally signed certificate in an X.509 certification procedure.

In Example 51, the subject matter of any one or more of Examples 36-50 optionally include wherein the cryptographic key is generated for use as: a Secure Shell (SSH) private key, a Secure File Transfer Protocol (SFTP) private key, a file encryption private key, a Secure Sockets Layer (SSL) cipher, a Transport Layer Security (TLS) cipher, a JavaScript-based application programming interface (API) authentication token, or a blockchain asymmetric key.

Example 52 is at least one machine readable medium including instructions, which when executed by a computing system, cause the computing system to perform any of the methods of Examples 35-51.

Example 53 is an apparatus comprising means for performing any of the methods of Examples 35-51.

Example 54 is a system, comprising: a server computing device operating as a certificate authority, the server computing device comprising at least one processor and a memory including instructions that, when executed by the at least one processor, cause the at least one processor to perform operations to: define an authentication policy, the authentication policy to require a user authentication factor for generation and access of a cryptographic key by a client certificate service provider; and sign a digital certificate in response to a certificate signing request; a client computing device operating as the client certificate service provider, the client computing device comprising at least one processor and a memory including instructions that, when executed by the at least one processor, cause the at least one processor to perform operations to: receive and process the authentication policy from the certificate authority; generate the cryptographic key in response to receipt of the user authentication factor defined by the authentication policy; associate the cryptographic key with an identifier of the authentication policy; generate attestation data, wherein the attestation data indicates generation of the cryptographic key in compliance with the authentication policy; and communicate the attestation data to the certificate authority, wherein the attestation data is validated by the certificate authority to verify generation of the cryptographic key in compliance with the authentication policy; wherein the certificate authority signs the digital certificate in response to validation of the attestation data.

In Example 55, the subject matter of Example 54 optionally includes wherein the authentication policy specifies use of at least one user authentication factor including: a password, a contextual answer, a biometric feature, a voice signature, a passcode, a personal identification number (PIN), or a personal security token, to be input by a human user to the client computing device.

In Example 56, the subject matter of any one or more of Examples 54-55 optionally include the client computing device including further instructions that, when executed by the at least one processor, cause the at least one processor to perform operations to: host an enrollment agent having at least one application programming interface, wherein in response to use of the application programming interface, the client certificate service provider authenticates with the user authentication factor specified by the authentication policy.

Example 57 is an apparatus to perform cryptographic operations based on an authentication policy, comprising: means for receiving an authentication policy from a policy broker, the authentication policy defining a requirement of a user authentication factor to generate and retrieve a cryptographic key; means for generating the cryptographic key in response to receipt of the user authentication factor defined by the authentication policy; means for generating attestation data, wherein the attestation data indicates generation of the cryptographic key in compliance with the authentication policy; and means for communicating the attestation data to the policy broker, wherein the attestation data is validated by the policy broker to verify generation of the cryptographic key in compliance with the authentication policy.

In Example 58, the subject matter of Example 57 optionally includes means for receiving the user authentication factor from a human user; wherein the authentication policy specifies use of at least one user authentication factor including: a password, a contextual answer, a biometric feature, a voice signature, a passcode, a personal identification number (PIN), user location information, or a personal security token.

In Example 59, the subject matter of Example 58 optionally includes means for generating the cryptographic key in response to receipt and verification of an input of the user authentication factor from the human user.

In Example 60, the subject matter of any one or more of Examples 58-59 optionally include means for enforcing the requirement of the user authentication factor in respective operations to generate and retrieve the cryptographic key.

In Example 61, the subject matter of any one or more of Examples 58-60 optionally include means for establishing a plurality of user authentication factors, prior to generation of the cryptographic key; and wherein the authentication policy defines a requirement of multi-factor authentication to generate and retrieve the cryptographic key, wherein the multi-factor authentication includes the user authentication factor and a second user authentication factor, and wherein the plurality of user authentication factors are used with the multi-factor authentication.

In Example 62, the subject matter of Example 61 optionally includes means for communicating, to the policy broker, an identification of the plurality of user authentication factors, wherein the authentication policy indicates respective user authentication factors for use in a plurality of software applications.

In Example 63, the subject matter of any one or more of Examples 58-62 optionally include wherein the authentication policy defines respective requirements for at least a first software application and a second software application, and wherein the authentication policy defines use of a first user authentication factor for the first software application and use of a second user authentication factor for the second software application.

In Example 64, the subject matter of any one or more of Examples 58-63 optionally include wherein the authentication policy is associated with an identifier, and wherein the attestation data indicates compliance with the authentication policy based on the identifier.

In Example 65, the subject matter of any one or more of Examples 58-64 optionally include means for generating the attestation data based on one or more of: manufacturer information, software or firmware executing inside a trusted execution environment, data protected by the trusted execution environment, at least one key protected by the trusted execution environment, or use of a blockchain technique.

In Example 66, the subject matter of any one or more of Examples 58-65 optionally include wherein the authentication policy is updated, by the policy broker, subsequent to generation of the cryptographic key, wherein the authentication policy is updated to change the requirement of the user authentication factor to subsequently retrieve the cryptographic key.

In Example 67, the subject matter of any one or more of Examples 58-66 optionally include means for receiving a request to access the cryptographic key from a data store; and means for accessing the cryptographic key in response to receipt of the user authentication factor defined by the authentication policy.

In Example 68, the subject matter of Example 67 optionally includes means for transmitting, to a verifier, second attestation data to indicate the receipt of the user authentication factor to access the cryptographic key, wherein the second attestation data indicates compliance with the authentication policy based on an identifier associated with the authentication policy.

In Example 69, the subject matter of Example 68 optionally includes means for receiving a first value that is input by a human user for performance of the user authentication factor to generate the cryptographic key; means for receiving a second value that is input by the human user for performance of the user authentication factor to access the cryptographic key; wherein the first value differs from a second value.

In Example 70, the subject matter of any one or more of Examples 58-69 optionally include means for creating a certificate signing request to transmit to the policy broker, wherein the cryptographic key is a private key used to sign the certificate signing request, wherein the certificate signing request includes a public key corresponding to the private key, and wherein the policy broker is a certificate authority.

In Example 71, the subject matter of Example 70 optionally includes means for receiving, from the policy broker in response to the certificate signing request, a signed client certificate, wherein the signed client certificate indicates an identifier of the authentication policy.

In Example 72, the subject matter of any one or more of Examples 58-71 optionally include the cryptographic key being generated for use in a digitally signed certificate in an X.509 certification procedure.

In Example 73, the subject matter of any one or more of Examples 58-72 optionally include wherein the cryptographic key is generated for use as: a Secure Shell (SSH) private key, a Secure File Transfer Protocol (SFTP) private key, a file encryption private key, a Secure Sockets Layer (SSL) cipher, a Transport Layer Security (TLS) cipher, a JavaScript-based application programming interface (API) authentication token, or a blockchain asymmetric key.

Example 74 is a system configured to perform operations of any one or more of Examples 1-73.

Example 75 is a method for performing operations of any one or more of Examples 1-73.

Example 76 is a machine readable medium including instructions that, when executed by a machine cause the machine to perform the operations of any one or more of Examples 1-73.

Example 77 is a system comprising means for performing the operations of any one or more of Examples 1-73.

In the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment.

What is claimed is:

1. A computing device to perform cryptographic operations based on an authentication policy, the computing device comprising processing circuitry to:
receive an authentication policy from a policy broker, wherein the authentication policy defines a requirement of a user authentication factor to generate and retrieve a cryptographic key;
generate the cryptographic key in response to receipt of the user authentication factor defined by the authentication policy;
generate attestation data, wherein the attestation data indicates generation of the cryptographic key in compliance with the authentication policy; and
communicate the attestation data to the policy broker, wherein the attestation data is validated by the policy broker to verify generation of the cryptographic key in compliance with the authentication policy.

2. The computing device of claim 1, wherein the authentication policy specifies use of at least one user authentication factor including: a password, a contextual answer, a biometric feature, a voice signature, a passcode, a personal identification number (PIN), user location information, or a personal security token, and wherein the user authentication factor is provided by a human user via input to the computing device.

3. The computing device of claim 2, wherein operations to generate the cryptographic key are further performed in response to receipt and verification of the input of the user authentication factor, the receipt and verification of the input of the user authentication factor performed by the computing device.

4. The computing device of claim 2, wherein the requirement of the user authentication factor is enforced by a hardware-secured cryptographic service of the computing device in respective operations to generate and retrieve the cryptographic key.

5. The computing device of claim 2, the processing circuitry further to:
establish a plurality of user authentication factors on the computing device prior to generation of the cryptographic key; and
wherein the authentication policy defines a requirement of multi-factor authentication to generate and retrieve the cryptographic key, wherein the multi-factor authentication includes the user authentication factor and a second user authentication factor, and wherein the plurality of user authentication factors established on the computing device are used with the multi-factor authentication.

6. The computing device of claim 5, wherein an identification of the plurality of user authentication factors established on the computing device are communicated to the policy broker, and wherein the authentication policy indicates respective user authentication factors for use in a plurality of software applications to execute on the computing device.

7. The computing device of claim 1, wherein the authentication policy is associated with an identifier, and wherein the attestation data indicates compliance with the authentication policy based on the identifier.

8. The computing device of claim 1, wherein the attestation data is generated based on one or more of: manufacturer information, software or firmware executing inside a trusted execution environment, data protected by the trusted execution environment, at least one key protected by the trusted execution environment, or use of a blockchain technique.

9. The computing device of claim 1, wherein the authentication policy is updated, by the policy broker, subsequent to generation of the cryptographic key, wherein the authentication policy is updated to change the requirement of the user authentication factor to subsequently retrieve the cryptographic key.

10. The computing device of claim 1, the processing circuitry further to:
receive a request to access the cryptographic key from a data store; and
access the cryptographic key in response to receipt of the user authentication factor defined by the authentication policy.

11. The computing device of claim 1, the processing circuitry further to:
transmit, to a verifier, second attestation data to indicate the receipt of the user authentication factor to access the cryptographic key, wherein the second attestation data indicates compliance with the authentication policy based on an identifier associated with the authentication policy.

12. The computing device of claim 1, the processing circuitry further to:
create a certificate signing request to transmit to the policy broker, wherein the cryptographic key is a private key used to sign the certificate signing request, wherein the certificate signing request includes a public key corresponding to the private key, and wherein the policy broker is a certificate authority.

13. The computing device of claim 12, the processing circuitry further to:
receive, from the policy broker in response to the certificate signing request, a signed client certificate, wherein the signed client certificate indicates an identifier of the authentication policy.

14. The computing device of claim 1, wherein the cryptographic key is generated for use as: a Secure Shell (SSH) private key, a Secure File Transfer Protocol (SFTP) private key, a file encryption private key, a Secure Sockets Layer (SSL) cipher, a Transport Layer Security (TLS) cipher, a JavaScript-based application programming interface (API) authentication token, or a blockchain asymmetric key.

15. At least one machine readable storage medium, comprising a plurality of instructions adapted to perform cryptographic operations based on an authentication policy, wherein the instructions, responsive to being executed with processor circuitry of a computing device, cause the computing device to:
receive an authentication policy from a policy broker, wherein the authentication policy defines a requirement of a user authentication factor to generate and retrieve a cryptographic key;
generate the cryptographic key in response to provision of the user authentication factor defined by the authentication policy;
generate attestation data, wherein the attestation data indicates generation of the cryptographic key in compliance with the authentication policy; and
communicate the attestation data to the policy broker, wherein the attestation data is validated by the policy broker to verify generation of the cryptographic key in compliance with the authentication policy.

16. The machine readable storage medium of claim 15, wherein the authentication policy specifies use of at least one user authentication factor including: a password, a contextual answer, a biometric feature, a voice signature, a passcode, a personal identification number (PIN), user location information, or a personal security token, and wherein the user authentication factor is provided by a human user via input to the computing device.

17. The machine readable storage medium of claim 16, wherein operations to generate the cryptographic key are further performed in response to receipt and verification of the input of the user authentication factor, the receipt and verification of the input of the user authentication factor performed by the computing device.

18. The machine readable storage medium of claim 16, wherein the requirement of the user authentication factor is enforced by a hardware-secured cryptographic service of the computing device in respective operations to generate and retrieve the cryptographic key.

19. The machine readable storage medium of claim 15, wherein the authentication policy is associated with an identifier, and wherein the attestation data indicates compliance with the authentication policy based on the identifier.

20. The machine readable storage medium of claim 15, wherein the attestation data is generated based on one or more of: manufacturer information, software or firmware executing inside a trusted execution environment, data protected by the trusted execution environment, at least one key protected by the trusted execution environment, or use of a blockchain technique.

21. A method to perform cryptographic operations based on an authentication policy, the method comprising electronic operations performed with a computing device, including:
receiving an authentication policy from a policy broker, the authentication policy defining a requirement of a user authentication factor to generate and retrieve a cryptographic key;
generating the cryptographic key in response to receipt of the user authentication factor defined by the authentication policy;
generating attestation data, wherein the attestation data indicates generation of the cryptographic key in compliance with the authentication policy; and
communicating the attestation data to the policy broker, wherein the attestation data is validated by the policy broker to verify generation of the cryptographic key in compliance with the authentication policy.

22. The method of claim 21, wherein the authentication policy specifies use of at least one user authentication factor including: a password, a contextual answer, a biometric feature, a voice signature, a passcode, a personal identification number (PIN), user location information, or a personal security token, and wherein the user authentication factor is provided by a human user via input to the computing device.

23. The method of claim 22, wherein operations to generate the cryptographic key are further performed in response to receipt and verification of the input of the user authentication factor, the receipt and verification of the input of the user authentication factor performed by the computing device.

24. The method of claim 22, wherein the authentication policy is associated with an identifier, and wherein the attestation data indicates compliance with the authentication policy based on the identifier.

25. The method of claim 22, wherein the attestation data is generated based on one or more of: manufacturer information, software or firmware executing inside a trusted execution environment, data protected by the trusted execution environment, at least one key protected by the trusted execution environment, or use of a blockchain technique.
